(19) United States
(12) Patent Application Publication
(10) Pub. No.: US 2015/0172825 A1
(43) Pub. Date: Jun. 18, 2015

(54) Method and Apparatus for an Acoustic Device Having a Coating

(71) Applicant: Knowles Electronics, LLC, Itasca, IL (US)

(72) Inventors: Tony K. Lim, Naperville, IL (US); Norman Dennis Talag, Woodridge, IL (US); Kurt B. Friel, Sycamore, IL (US)

(21) Appl. No.: 14/558,194

(22) Filed: Dec. 2, 2014

Related U.S. Application Data
(60) Provisional application No. 61/915,620, filed on Dec. 13, 2013.

(51) Int. Cl. H04R 19/04; H04R 31/00

(52) U.S. Cl. CPC H04R 19/04; H04R 31/00; H04R 2231/00; H04R 2410/00

(57) ABSTRACT

An acoustic device comprises a substrate and a housing that affixes to the substrate via an affixment material to thereby encapsulate at least one acoustic transducer such as a microphone. By one approach the housing comprises brass but is nevertheless unplated. A coating is disposed on the exterior surface of the housing and of the affixment material. These teachings will also accommodate covering some or all of the exterior, exposed surface of substrate.

### RELATED APPLICATION(S)

This application claims the benefit of U.S. Provisional application No. 61/915,620, filed Dec. 13, 2013, entitled Method and Apparatus for an Acoustic Device Having a Coating, which is incorporated by reference in its entirety herein.

### TECHNICAL FIELD

This invention relates generally to acoustic devices and more specifically to housings for these devices.

### BACKGROUND

MicroElectroMechanical System (MEMS) devices include, for example, microphones. In the case of a MEMS microphone, sound energy enters through a sound port and vibrates a diaphragm. This action creates a corresponding change in electrical potential between the diaphragm and a back plate disposed near the diaphragm. This voltage represents the sound energy that has been received. Typically, the voltage is then transmitted to an electric circuit (for example, an integrated circuit such as an application specific integrated circuit (ASIC)). Further processing of the signal may be performed by this electrical circuit. For instance, amplification or filtering functions may be performed on the signal at the integrated circuit.

The internal components (such as the aforementioned integrated circuit and MEMS device) of an acoustic device such as a microphonic acoustic device are typically disposed within a housing. The housing is often akin to an open-sided box that is disposed over the active components of the device to thereby encapsulate these internal components within a sealed cavity that is formed by the housing and a substrate upon which the housing mounts.

In many cases the housing is coupled to the substrate with solder paste. The housing often comprises brass (or a brass alloy) in order to serve as a Faraday cage to isolate the components of the acoustic device from electrical interference. While unplated brass may adhere properly to a substrate using only solder, in practice a solder connection to brass is not as robust as a solder connection to a gold-plated surface. This situation, in turn, provides an incomplete atmospheric seal for the aforementioned cavity. This incomplete seal, in turn, can negatively impact the performance of the acoustic device.

Brass also tarnishes. Tarnishing, in turn, can negatively impact the cosmetic appearance of the housing. As the housing often comprises a substantial part of the acoustic device, that diminution in cosmetic appearance can considerably negatively affect the overall appearance of the resultant acoustic device.

Accordingly, the prior art typically provides for plating the brass housing with a material such as gold. Gold will not tarnish. In addition, gold ensures a high-quality solder seal that in turn provides a good atmospheric seal for the aforementioned cavity. Unfortunately, gold (and many other potentially-useful plating materials) tend to be relatively expensive and hence considerably increase the cost of the resultant acoustic device.

Also, a brass housing having gold plating typically offers less radio frequency protection to a MEMS microphone than an un-plated brass housing (at least in part due to the typical practice of first plating the brass housing with nickel and then plating the nickel layer with gold). Accordingly, using plating materials such as gold can negatively impact other important performance factors in such an application setting.

### BRIEF DESCRIPTION OF THE DRAWINGS

The above needs are at least partially met through provision of the method and apparatus for an acoustic device having a coating described in the following detailed description, particularly when studied in conjunction with the drawings, wherein:

FIG. 1 comprises a flow diagram as configured in accordance with various embodiments of the invention;

FIG. 2 comprises an exploded perspective view as configured in accordance with various embodiments of the invention;

FIG. 3 comprises a side-elevational partially-sectioned view as configured in accordance with various embodiments of the invention; and

FIG. 4 comprises a side-elevational view as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an acoustic device comprises a substrate and a housing that affixes to the substrate via an affixment material to thereby encapsulate at least one acoustic transducer such as a microphone element. By one approach the housing comprises unplated brass. A coating is disposed on the exterior surface of the housing and of the affixment material.

By one approach the affixment material comprises solder paste. By another approach the affixment material comprises a conductive epoxy of choice.

By one approach the aforementioned coating comprises an electrically-conductive coating. Examples in these regards include, but are not limited to, an adhesive carrier having electrically-conductive metal particles (such as but not limited to silver particles) disposed therein, electrically-conductive organic ink, and so forth. By another approach the aforementioned coating is non-electrically conductive and might comprise, for example, any of a variety of inks, paints, and the like.

So configured, the coating avoids any concerns regarding tarnishing Accordingly, these teachings provide a very simple and inexpensive way to preserve the cosmetic appeal of the resultant acoustic device.

In addition, the coating is sufficient to seal any porosity imperfections in the connection of the housing to the substrate to thereby greatly improve the atmospheric integrity of the cavity formed by the housing and the substrate. This seal thereby in turn helps the aforementioned acoustic transducer to operate in an efficient and effective manner.

These teachings are highly flexible in practice and will accommodate a wide variety of coating materials and application methodologies. These teachings in turn permit existing technologies and materials to be considerably leveraged in favor of continued relevance and utility while nevertheless avoiding cosmetic and/or cost issues associated with prior plating practices.

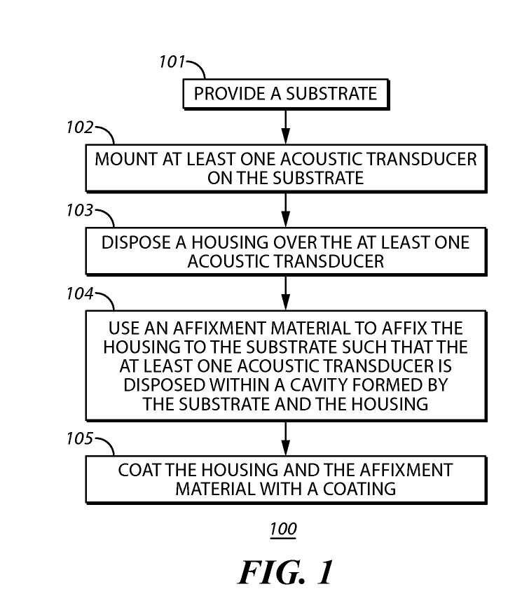

These and other benefits may become clearer upon making a thorough review and study of the following detailed description. Referring now to the drawings, and in particular to FIG. 1, an illustrative process 100 that is compatible with many of these teachings will now be presented.

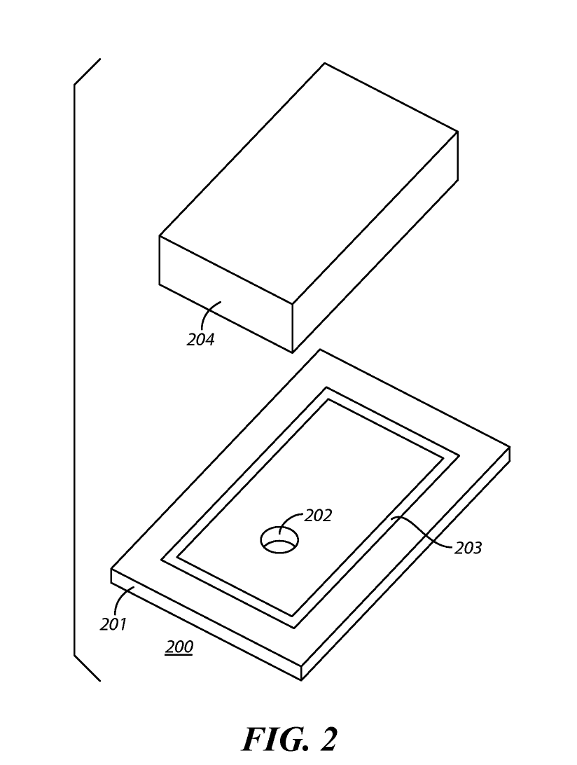

At block 101 this process 100 provides for provision of a substrate. FIG. 2 provides one illustrative example in these regards. In this example the substrate 201 comprises a circuit board formed of FR-4 material. This substrate 201 has an opening 202 formed therethrough to provide an acoustic pathway to an acoustic transducer as described below.

This substrate 201 also has an affixment material 203 disposed thereon. This affixment material 203 serves to affix a housing to the substrate 201 and may comprise, for example, solder paste, a conductive epoxy, or other appropriate material of choice. In this illustrative example the affixment material 203 has a form factor that matches the form factor of the housing to be affixed to the substrate 201 such that the affixment material 203 is continuously disposed fully around a base of the housing. In this example the affixment material 203 comprises a continuous, uninterrupted deposit of material.

In a typical application setting this substrate 201 would also likely have other features as well such as, but not limited to, electrically-conductive circuit traces, bonding pads, and so forth. Such practices are well known in the art and require no further elaboration here. For the sake of clarity such details are not provided in these illustrations.

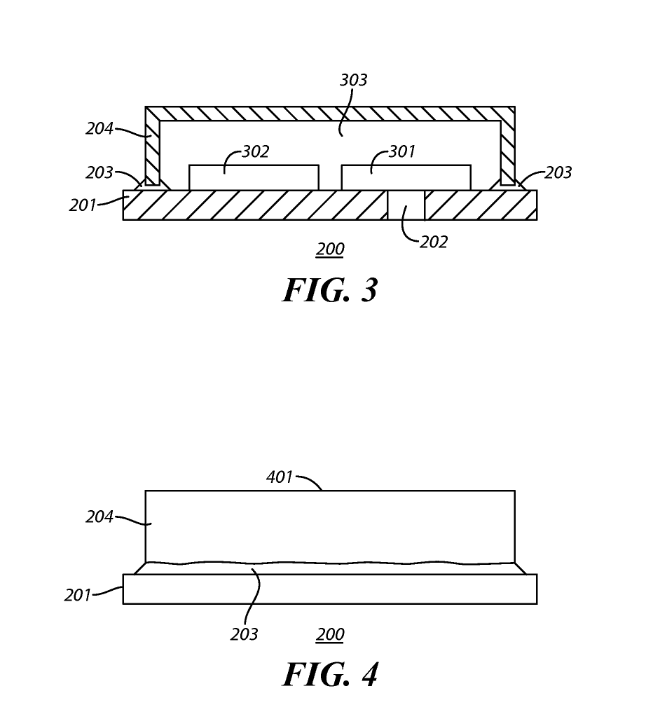

Referring to both FIGS. 1 and 3, at block 102 this process 100 provides for mounting at least one acoustic transducer 301 on the substrate 301. These teachings are flexible in these regards and will accommodate a variety of specific components. In this particular illustrative example the acoustic transducer 301 comprises a MEMS microphone which are known in the art. As shown in FIG. 3, the acoustic transducer 301 is juxtaposed with respect to the aforementioned opening 202 in the substrate 201. So disposed, acoustic energy can readily pass through the opening 202 to reach the acoustic transducer 301 to thereby facilitate the acoustic transducers' role as a microphone component.

These teachings will accommodate also mounting any number of other components on the substrate 201. As a simple illustration in these regards, an integrated circuit 302 is also mounted on the substrate 201. In a typical application setting this integrated circuit 302 serves, at least in part, to process electrical signals provided by the acoustic transducer 301. Accordingly, the integrated circuit 302 will typically electrically couple to the acoustic transducer 301 via one or more circuit traces, leads, or the like (not shown). Such practices are well known in the art and require no further elaboration here.

Referring to FIGS. 1, 2, and 3, at block 103 the process 100 provides for disposing a housing 204 over the aforementioned acoustic transducer 301. This housing 204 will typically comprise a base metal such as brass (though other materials such as stainless steel or even gold can be successfully employed if desired). In this example the housing 204 has a rectangular form factor though other form factors can of course be employed if desired. The size of the housing 204 can vary with the needs of application setting. Generally speaking, the overall acoustic device 200 will often have a length in the range of about 2.0 mm to about 5.0 mm, a width in the range of about 1.5 mm to about 4.0 mm, and a height in the range of about 0.8 to about 1.3 mm and the housing 204 will be sized somewhat smaller.

In this example, and contrary to typical prior art practice in these regard, the housing 204 is unplated (either in whole or in part). (As used herein, “plated” will be understood to refer to the deposition of a layer of metal to the housing metal via, for example, the use of heat and pressure to fuse the two metals, vapor deposition, sputter deposition, and so forth.) Accordingly, and by way of illustration, when the housing 204 comprises brass, the point of contact between the housing 204 and the affixment material 203 will comprise a point of direct contact between brass and the affixment material 203.

Referring in particular to FIGS. 1 and 3, at block 104 the process 100 provides for using the aforementioned affixment material 203 to affix the housing 204 to the substrate 201 such that the acoustic transducer 301 (or other similarly-situated components, such as the aforementioned integrated circuit 302) are disposed within a cavity 303 that is formed by the substrate 201, the housing 204, and the affixment material 203. As noted above, however, when the housing 204 comprises a material such as brass, the physical connection facilitated by the affixment material 203 will often be somewhat compromised in terms of failing to constitute a complete environmental seal. In particular, the porosity of this connection will often be enough to impair the acoustical seal of the cavity 303. The corresponding leakage of acoustical energy, in turn, can and will impair the efficiency and/or accuracy of the performance of the acoustic transducer 301 and hence the overall performance of the resultant acoustic device 200.

Accordingly, and referring now to FIGS. 1 and 4, at block 105 this process provides for coating an exterior surface of the housing 204 and the affixment material 203 with a coating 401 to thereby seal the acoustic transducer 301 within the housing 204. By one approach this coating 401 can completely cover the entire exterior surface of the housing 204 and/or the entire exterior surface of the affixment material 203. These teachings will also accommodate covering some or all of the exterior, exposed surface of the substrate 201 itself.

By one approach the coating 401 can comprise a material that is not electrically conductive. In this case any of a variety of paints or inks may serve well in these regards. To facilitate electrical testing of the resultant acoustic device 200, however, it can be useful to make electrical contact with the housing 204 (via, for example, an electrically-conductive probe). To facilitate such an approach, the coating 401 on the housing 204 can be incomplete to thereby provide ready access to the electrically-conductive material that comprises the housing 204. Such an opening can assume any of a variety of form factors such as, but not limited to, a small circle, oval, square, rectangle, and so forth.

These teachings will also accommodate using a coating 401 that comprises an electrically-conductive coating. By one approach this electrically-conductive coating 401 comprises an electrically-conductive organic ink. By another approach this electrically-conductive coating 401 comprises an adhesive carrier of choice having small electrically-conductive metal particles (such as, but not limited to, silver particles) disposed uniformly therein. Generally speaking these metal particles can be very small and on the scale of only a few nanometers or micrometers in size. As one illustrative example the electrically-conductive coating 401 may comprise an adhesive carrier having electrically-conductive metal particles disposed therein wherein at least ninety-five percent (or even one hundred percent) of the metal particles are no larger than about fifty or sixty micrometers in length.

This coating 401 can comprise a single application layer or multiple application layers as desired. These teachings will also accommodate, if desired, applying multiple layers of different coating materials. The coating 401 can be applied using any appropriate application methodology including, for example, any of a variety of known spray painting, liquid immersion, and ink-application techniques. (To be clear, it will be further understood that, as used herein, this coating does not constitute plating.)

So configured, the resultant acoustic device 200 can employ an unplated electrically-conductive housing 204 that connects to a corresponding substrate 201 via an affixment material 203 such as solder paste and that nevertheless provides an excellent seal between and amongst the foregoing components to thereby seal a corresponding acoustic transducer 301 within the cavity 303 formed by these components. Because the coating 204 that helps to achieve this seal (and the manner by which the coating 204 is applied) is considerably less expensive than typical plating materials and plating processes, these teachings provide a high level of device performance at a considerably reduced cost. Such a coating 401 will also serve to protect the housing 204 against tarnishing and can itself provide a uniform and cosmetically-pleasing appearance.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An acoustic device, comprising:
a substrate;
a housing affixed on the substrate by an affixment material;
a coating disposed on an exterior surface of the housing and an exterior surface of the affixment material;
at least one acoustic transducer disposed on the substrate and within the housing.

2. The acoustic device of characterization 1 wherein the housing is comprised of brass.

3. The acoustic device of characterization 1 wherein the housing consists of brass.

4. The acoustic device of characterization 1 wherein the affixment material comprises at least one of a solder and a conductive epoxy.

5. The acoustic device of characterization 4 wherein the affixment material is continuously disposed fully around a base of the housing.

6. The acoustic device of characterization 1 wherein the coating comprises an electrically-conductive coating.

7. The acoustic device of characterization 6 wherein the electrically-conductive coating comprises an adhesive carrier having electrically-conductive metal particles disposed therein wherein at least ninety-five percent of the metal particles are no larger than fifty micrometers in length.

8. The acoustic device of characterization 6 wherein the electrically-conductive coating comprises an electrically-conductive organic ink.

9. The acoustic device of characterization 1 wherein the coating is disposed on the exterior surface of the affixment material sufficient to seal the acoustic transducer within the housing.

10. The acoustic device of characterization 1 wherein the housing has a length in the range of about 2.0 mm to about 5.0 mm, a width in the range of about 1.5 mm to about 4.0 mm, and a height in the range of about 0.8 to about 1.3 mm.

11. A method comprising:
providing a substrate;
mounting at least one acoustic transducer on the substrate;
disposing a housing over the at least one acoustic transducer;
using an affixment material to affix the housing to the substrate such that the at least one acoustic transducer is disposed within a cavity formed by the substrate and the housing;
coating the housing and the affixment material with a coating.

12. The method of characterization 11 wherein the housing is comprised of brass.

13. The method of characterization 11 wherein the housing consists of brass.

14. The method of characterization 11 wherein the affixment material comprises at least one of a solder and a conductive epoxy.

15. The method of characterization 14 wherein the affixment material is continuously disposed fully around a base of the housing.

16. The method of characterization 11 wherein the coating comprises an electrically-conductive coating.

17. The method of characterization 16 wherein the electrically-conductive coating comprises an adhesive carrier having nano-scale electrically-conductive metal particles particles disposed therein wherein at least ninety-five percent of the metal particles are no larger than fifty micrometers in length.

18. The method of characterization 16 wherein the electrically-conductive coating comprises an electrically-conductive organic ink.

19. The method of characterization 11 wherein the coating is disposed on the exterior surface of the affixment material sufficient to seal the acoustic transducer within the cavity.

20. The method of characterization 11 wherein the housing has a length in the range of about 2.0 mm to about 5.0 mm, a width in the range of about 1.5 mm to about 4.0 mm, and a height in the range of about 0.8 to about 1.3 mm.
